(19) United States
(12) Patent Application Publication
(10) Pub. No.: US 2002/0143625 A1
(43) Pub. Date: Oct. 3, 2002

(54) Method for raising funds.

(76) Inventor: Antoon Walter Waldeyer, Merksem (BE)

Correspondence Address: BACON & THOMAS, PLLC, 4th Floor, 625 Slaters Lane, Alexandria, VA, 22314-1176, US

(21) Appl. No.: 09/824,105

(22) Filed: Apr. 3, 2001

(51) Int. Cl. G06F 17/60

(52) U.S. Cl. 705/14

(57) ABSTRACT

The present invention consists of a simple method for raising funds by using existing communication means. Whenever a giver (1) makes a wired or wireless communication link (11) with an action-specific connection at a data processing entity (2) his identity is known, allowing this data processing entity to charge the giver with an amount that covers both the operational costs of the data processing entity and an action-specific amount that the giver chooses to be charged with by the data processing entity but which the latter has to transfer (12) to the receiver (3) who investigates the charity projects (4) and allocates the raised funds (13) less his overall operational and organizational costs. The amount to be transferred can either be preset by the receiver or can be selected by the giver. The same principle could be used to create a lottery when the data processing entity would, on behalf of the organizer of the lottery, store the identification information of all givers on a secure memory. In this case the receiver (3) would become the organizer of the lottery of which the winner(s) (5) would periodically be drawn from the list with the givers' identity.

### BACKGROUND OF THE INVENTION

The availability of global round the clock information emphasizes the need for a greater solidarity in helping those who are struck by disaster or misfortune. Although many governments and international aid agencies have put aside funds to cover the first needs while storing specific goods and medicine to be able to respond more quickly to any distress call from countries or regions in urgent need, it is a fact that in many cases the disaster aid is delayed due to the lack of financial means while the collecting of funds is delayed due to organizational or administrative shortcomings.

A consequential problem of this situation is that, due to the overdose—and thus the volatility—of global round the clock information, solidarity weakens by the hour. Hence, the saying that every minute counts in disaster relief does not only concern the disaster area, but in a different context also the donator area.

### SUMMARY OF THE INVENTION

The present invention intends to decrease to a strict minimum the time gap between the first call for international aid and the starting of a campaign to raise funds by using the existing means of wireless and wired communication. Furthermore, many governments, aware of the necessities of countries or regions in need, have decided to create state lotteries that make use of the people's interest in gambling in order to generate funds that are also used to finance aid agencies or charity projects.

This aspect is also part of the present invention as it creates the possibility to organize a lottery that draws one or several winners from those givers who contributed in raising the action-specific funds by reserving a part of the collected funds for distribution to the winner(s) of the lottery. Another derivative of this invention is the creation of a pure lottery where none of the collected funds are spent on charity.

The present invention consists of a simple method for raising funds by using the existing communication means such as wired or wireless telephony, debit or credit or cash card terminals or the Internet. Whenever a communication link is made by for example a wired or wireless telephone, a debit or credit or cash card reader, or through an on-line link on the Internet, the identity of the maker of this link is known due to the corresponding identification information allowing for instance the charging of the operational and the intended costs.

A user of a fixed or cellular telephone will either receive an invoice for both the use and the duration of the respective telephone calls and the operational costs related to it or will the corresponding amount see charged through his credit card or debited from his bank account, a user of a debit or credit card will see his account charged with both the expenses made through this card and the operational costs related to it, a user of a cash card will see his card charged with both the, expenses made through this card and the operational costs related to it, a user of an on-line link with the website of his financial institution will see his account charged with both the expenses made through this on-line link and the operational costs related to it, a user purchasing goods or services through an on-line link with a website will see his credit card account see charged with an amount that covers both the expenses made through this on-line link and the operational costs related to it. In all cases it is therefore possible to create an action-specific connection where the operational cost of the link is increased with a certain amount that is willingly and knowingly charged to the user.

This increase can either be a fixed amount, an amount that is selected from a variety of amounts proposed to the user, or an amount that is composed by the user himself.

A user of a fixed or wireless telephone could either choose from a variety of action-specific calling numbers where each number represents a different amount that will be charged supplementary to the operational costs, or could be invited after having called the action-specific calling number to choose from a variety of options which he has to activate by pressing a number or a series of numbers, or could be invited after having called the action-specific calling number to compose himself the selected amount he would like to be charged with by pressing the number corresponding with this amount.

Moreover, a user of a wireless telephone could be invited to send an SMS to the action-specific calling number and leave the message empty when he wants to be charged with the fixed amount or type the amount he wants to be charged with.

A user of a pay phone could either choose from a variety of action-specific calling numbers where each number represents a different amount that he has to pay in cash before his connection would be accepted, or could be invited after having called the action-specific calling number to choose from a variety of options which he has to activate by pressing a number or a series of numbers and introduce the corresponding cash, or could be invited after having called the action-specific calling number to introduce as many cash as he wants to donate, the inconvenience of this being that in none of these situations the identity of the donator is known.

A user of a debit or credit or cash card can after having introduced his card in the corresponding card reader and where necessary having pressed his PIN-code to enter the system be invited to select an option button referring to the specific action where he could choose from a variety of options such as the selection of one field from a series of fields representing different action-specific amounts that will be charged to his account or deducted from his cash card, or a field allowing him to compose himself the selected amount he would like to be charged with by pressing the number corresponding with this amount. A user of an on-line Internet link with a website related to the specific action can either after having given the requested information on his credit card or after having entered his security login code(s) to enter the concerned system be invited to select an option button referring to the specific action where he could choose from a variety of options such as the selection of one field from a series of fields representing different action-specific amounts that will be charged to his account or deducted from his credit or debit card, or a field allowing him to compose himself the selected amount he would like to be charged with by pressing the number corresponding with this amount.

In all cases, with the exception of the cash payment on a cash-accepting telecommunication device, the identity of the maker of the link is known or traceable. Hence, when a periodic list is made of all makers of a link, in essence all givers, it is possible to draw from this list one or several winners and thus create a lottery based on the principle of fundraising as is explained herewith, and either use a part or the whole of the raised funds less the operational costs as prize money. The previous is given as an example without any limitative character of a preferred embodiment of a method.

### BRIEF DESCRIPTION OF THE DRAWINGS

FIG. 1 is a block diagram showing a general arrangement of a fundraising method and the thereof resulting combined and pure lottery according to an embodiment of the present invention;

FIG. 2 is a view showing a flow chart for illustrating the flow of processing of the fundraising part as shown in FIG. 1;

FIG. 3 is a view showing a flow chart for illustrating the flow of processing of the fundraising part in combination with a lottery as shown in FIG. 1;

FIG. 4 is a view showing a flow chart for illustrating the flow of processing of the pure lottery shown in FIG. 1.

### DESCRIPTION OF THE PREFERRED EMBODIMENTS

In the following, the present invention will be described in detail in conjunction with exemplary embodiments thereof with reference to the accompanying drawings.

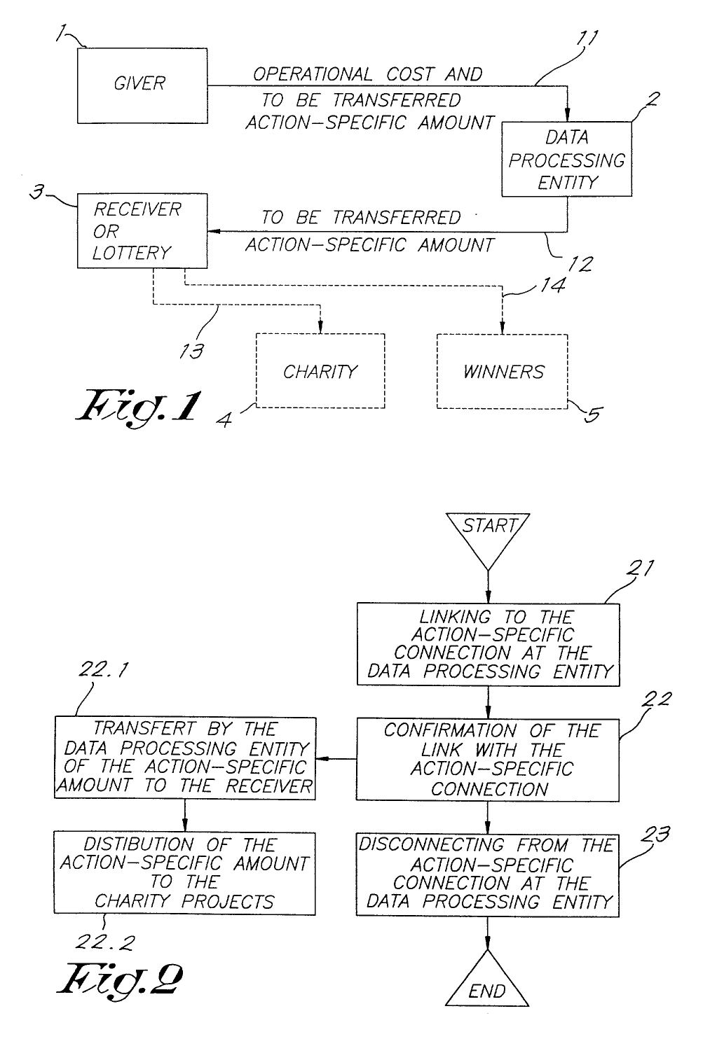

FIG. 1 shows a block diagram of a general arrangement of a fundraising method and the thereof resulting combined and pure lottery. In FIG. 1, a reference numeral 1 denotes a giver or donator, or in the case of a lottery a player.

Numeral 2 denotes a data processing entity, which can either be a telecommunication company or a financial institution or a lottery company or an institution related to the fundraising, which is connected to the giver 1 by a wired or wireless link 11 representing the flow of the debit order from the giver to the collecting data processing entity of both the operational cost and the action-specific amount.

Numeral 3 denotes a receiver, or in the case of a lottery its organizer, which is connected to the data processing entity by a signal line 12 representing the flow of the credit order from the raised funds from the data processing entity to the receiver less the operational costs of the data processing entity, or in the case of a lottery to its organizer.

In the case of a fundraising combined with a lottery, numeral 4 denotes the charity where signal line 13 represents the flow of the raised funds to be distributed to the charity projects financed by the receiver less his operational costs 3, while numeral 5 denotes the winner (s) of the lottery where signal line 14 represents the flow of the prize money to be distributed to the winner(s) by the lottery organizer 3 less his operational costs.

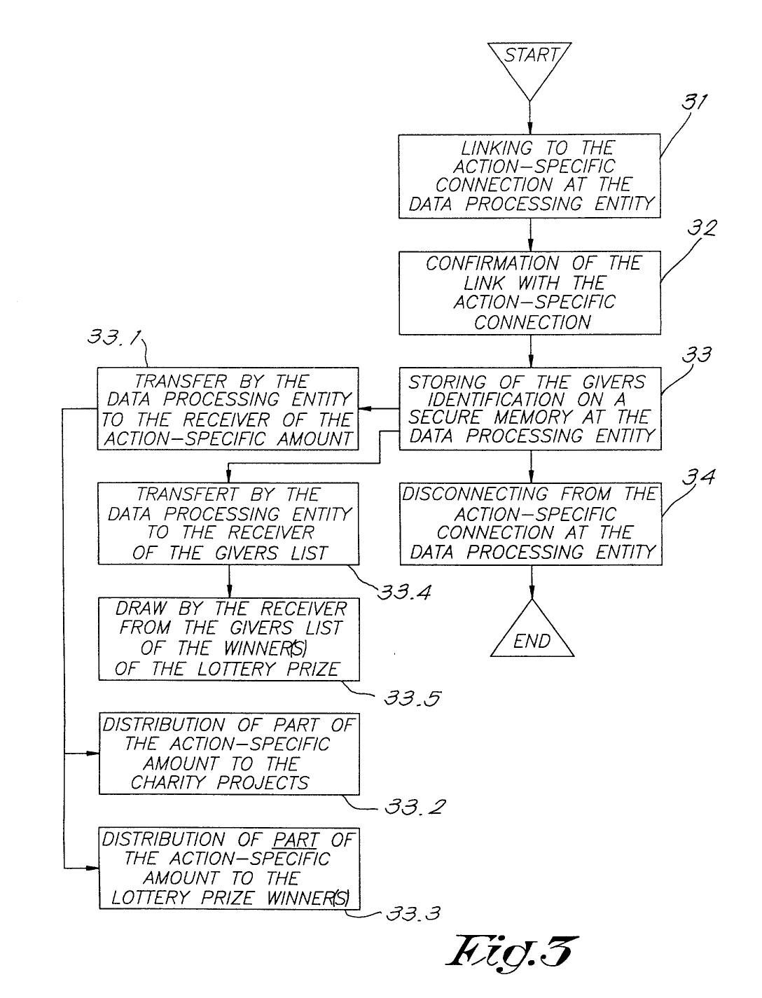

FIG. 2 shows in a flow chart a processing flow of the fundraising part where reference numeral 21 represents the linking of the giver to the action-specific connection at the data processing entity which is a fixed or wireless connection made by for example a fixed or wireless telephone, a credit or debit or cash card terminal, or an on-line link with a website related to the specific action.

Reference numeral 22 represents the confirmation of the link with the action-specific connection at the data processing entity and either consists of the simple establishment of the connection or the confirmation of the selected option made by the giver. Reference numeral 23 represents the disconnection from the action-specific connection at the data processing entity. Reference numeral 22.1 represents the transfer by the data processing entity to the receiver of the action specific amount less the operational costs of the data processing entity. Reference numeral 22.2 represents the distribution of the action-specific amount to the respective charity projects less the operational costs of the receiver.

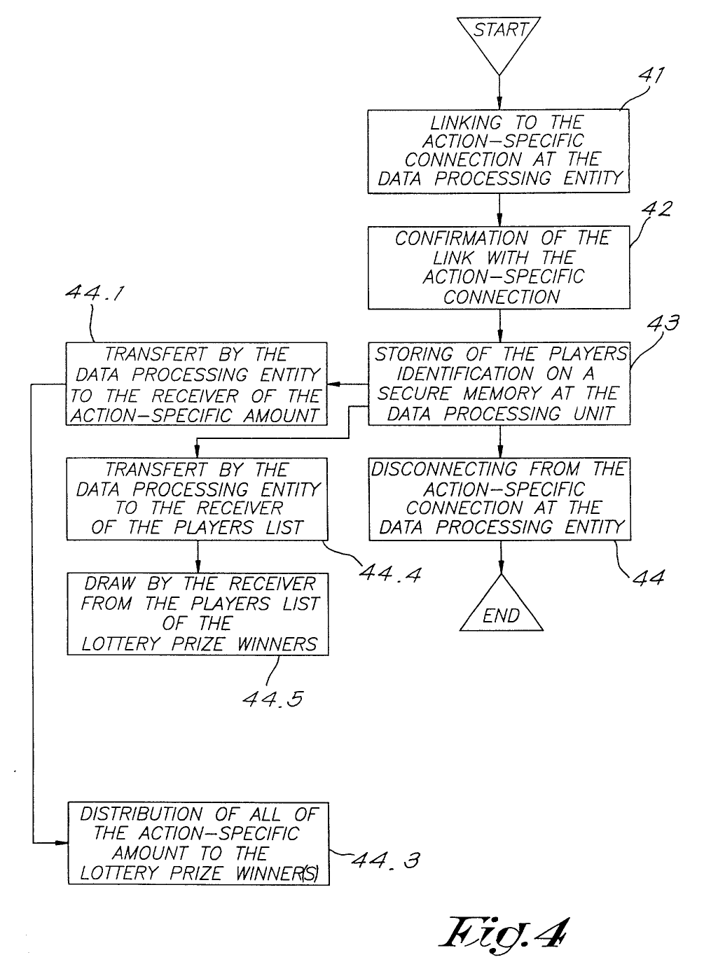

FIG. 3 shows in a flow chart a processing flow of the fundraising part combined with a lottery where reference numeral 31 represents the linking of the giver to the action-specific connection at the data processing entity which is a fixed or wireless connection made by for example a fixed or wireless telephone, a credit or debit or cash card terminal, or an on-line link with a website related to the specific action.

Reference numeral 32 represents the confirmation of the link with the action-specific connection at the data processing entity and either consists of the simple establishment of the connection or the confirmation of the selected option made by the giver.

Reference numeral 33 represents the storing of the givers' identification on a secure memory at the data processing entity. Reference numeral 34 represents the disconnection from the action-specific connection at the data processing entity. Reference numeral 33.1 represents the transfer by the data processing entity to the receiver of the action specific amount less the operational costs of the data processing entity.

Reference numeral 33.4 represents the transfer of the stored list of the givers from the data processing entity to the receiver. Reference numeral 33.5 represents the draw of the winner(s) of the lottery by the receiver. Reference numeral 33.2 represents the distribution of part of the action-specific amount to the respective charity projects less the operational costs of the receiver.

Reference numeral 33.3 represents the distribution of part of the action-specific amount to the winner(s) of the lottery prize less the operational costs of the receiver.

FIG. 4 shows in a flow chart a processing flow of the pure lottery where reference numeral 41 represents the linking of the player to the action-specific connection at the data processing entity which is a fixed or wireless connection made by for example a fixed or wireless telephone, a credit or debit or cash card terminal, or an on-line link with a website related to the specific action.

Reference numeral 42 represents the confirmation of the link with the action-specific connection at the data processing entity and either consists of the simple establishment of the connection or the confirmation of the selected option made by the player.

Reference numeral 43 represents the storing of the players' identification on a secure memory at the data processing entity.

Reference numeral 44 represents the disconnection from the action-specific connection at the data processing entity. Reference numeral 44.1 represents the transfer by the data processing entity to the receiver of the action specific amount less the operational costs of the data processing entity. Reference numeral 44.4 represents the transfer of the stored list of the players from the data processing entity to the receiver. Reference numeral 44.5 represents the draw of the winner(s) of the lottery by the receiver. Reference numeral 44.3 represents the distribution of the totality of the action-specific amount to the winner(s) of the lottery prize less the operational costs of the receiver.

Although several specific embodiments of the invention have been described, the invention is not limited by those descriptions, and rather it is to be construed in accordance with the attached claims.

Having thus described my invention, what I claim as new, and desire to secure by Letters Patent is:

1.- A method for raising funds by using existing communication means comprising the steps of:
a) Providing an operational fixed or wireless telephone or similar telecommunication connection connecting any incoming telecommunication call through the services of a selected data processing entity with a specific receiver,
b) Whereas the simple establishment of said telecommunication connection at said data processing entity between said originator and said receiver is enough to generate the confirmation of the connection,
c) Whereas it has been agreed with said data processing entity that the price of the incoming call charged to the originator of the incoming call consists of a part representing the operational costs of said data processing entity and another part representing an action-specific amount to be forwarded by said data processing entity to said receiver of the call.

2.- The method of claim 1 wherein after the establishment of said telecommunication connection at said data processing entity between said originator and said receiver said originator is offered the possibility to choose from a variety of options representing the selection of different action-specific amounts said originator is wanting to be charged with by said data processing entity and which said originator has to activate the chosen one by pressing a number or a series of numbers as indicated by said data processing entity.

3.- The method of claim 1 wherein after the establishment of said telecommunication connection at said data processing entity between said originator and said receiver said originator is offered the possibility to compose himself the action-specific amount said originator would like to be charged with by pressing the number corresponding with this amount.

4.- The method of claim 1, wherein the identity of said originator is known or traceable and can be stored in a memory of which periodically one or several identities can be drawn to make one or several winners of a lottery of which the prize money is construed of part or the whole of the funds transferred from said data processing entity to said receiver less the operational costs of the receiver.

5.- A method for raising funds by using communication means of a wireless telephone or similar telecommunication device comprising the steps of:
a) Establishing through the SMS-mode of said telecommunication device a connection with said selected data processing entity,
b) Whereas the simple establishment of said SMS connection at said data processing entity between said originator and said receiver without even adding a single SMS-related character is enough to generate the confirmation of the connection,
c) Whereas it has been agreed with said data processing entity that the price of the incoming call charged to the originator of the incoming call consists of a part representing the operational costs of said data processing entity and another part representing an action-specific amount to be forwarded by said data processing entity to said receiver of the call.

6.- The method of claim 5 wherein after the establishment of said telecommunication connection at said data processing entity between said originator and said receiver said originator is offered the possibility to compose himself with SMS-related characters the action-specific amount said originator would like to be charged with by pressing the number corresponding with this amount.

7.- The method of claim 5, wherein the identity of said originator is known or traceable and can be stored in a memory of which periodically one or several identities can be drawn to make one or several winners of a lottery of which the prize money is construed of part or the whole of the funds transferred from said data processing entity to said receiver less the operational costs of the receiver.

8.- A method for raising funds by using communication means of debit or credit or cash card activated card readers comprising the steps of:
a) Establishing through the terminal of said card reading device a connection with a selected data processing entity such as a financial or related action-specific institution by introducing said debit or credit or cash card into said card reading device and where necessary having pressed the PIN-code to enter the system,
b) Whereas after establishment of said connection at said card reading terminal said originator selects the option button referring to a fixed action-specific amount which will be charged to his account or will be deducted from his cash card,
c) Whereas it has been agreed with said data processing entity that the price of the transaction charged to said originator consists of a part representing the operational costs of said data processing entity and another part representing an action-specific amount to be transferred to the account of the receiver.

9.- The method of claim 8 wherein after the establishment of said connection at said data processing entity between said originator and said card reading device said originator is offered the possibility to choose from a variety of options representing the selection of different action-specific amounts said originator is wanting to be charged with by said data processing entity and which said originator has to activate the chosen one by pressing a number or a series of numbers or fields or buttons as indicated by said data processing entity.

10.- The method of claim 8 wherein after the establishment of said connection at said data processing entity between said originator and said card reading device said originator is offered the possibility to compose himself the action-specific amount said originator would like to be charged with by pressing the number corresponding with this amount.

11.- The method of claim 8, wherein the identity of said originator is known or traceable and can be stored in a memory of which periodically one or several identities can be drawn to make one or several winners of a lottery of which the prize money is construed of part or the whole of the funds transferred from said data processing entity to said receiver less the operational costs of the receiver.

12.- A method for raising funds by using communication means of an on-line Internet link comprising the steps of:
a) Establishing through a terminal said on-line Internet connection with a selected data processing entity such as a financial or related action-specific website by having given the requested information on his credit card or after having entered his security login code(s) to enter the concerned system,
b) Whereas, after establishment of said connection at said website, said originator selects the option button referring to a fixed action-specific amount which will be charged to his account or will be deducted from his credit card,
c) Whereas it has been agreed with said data processing entity that the price of the transaction charged to said originator consists of a part representing the operational costs of said data processing entity and another part representing an action-specific amount to be transferred to the account of the receiver.

13.- The method of claim 12, wherein after the establishment of said connection at said data processing entity between said originator and said website said originator is offered the possibility to choose from a variety of options representing the selection of different action-specific amounts said originator is wanting to be charged with by said data processing entity and which said originator has to activate the chosen one by pressing a number or a series of numbers or fields or buttons as indicated by said data processing entity.

14.- The method of claim 12 wherein after the establishment of said connection at said data processing entity between said originator and said website said originator is offered the possibility to compose himself the action-specific amount said originator would like to be charged with by pressing the number corresponding with this amount.

15.- The method of claim 12, wherein the identity of said originator is known or traceable and can be stored in a memory of which periodically one or several identities can be drawn to make one or several winners of a lottery of which the prize money is construed of part or the whole of the funds transferred from said data processing entity to said receiver less the operational costs of the receiver.

16.- A method for raising funds by using communication means of a pay phone or similar cash accepting telecommunication linked device comprising the steps of:
a) Establishing through the terminal of said cash accepting telecommunication device an operational fixed or wireless telephone or similar telecommunication connection connecting said cash accepting telecommunication device call through the services of a selected data processing entity with an action-specific receiver,
b) Whereas depending of the type of said cash accepting telecommunication device prior or after establishment of said connection at said cash accepting telecommunication device said originator introduces the cash necessary to establish or confirm the action-specific connection,
c) Whereas it has been agreed with said data processing entity that the price of the transaction charged to said originator consists of a part representing the operational costs of said data processing entity and another part representing an action-specific amount to be transferred to the account of the receiver.

17.- The method of claim 16 wherein after the establishment of said telecommunication connection at said data processing entity between said originator and said receiver said originator is offered the possibility to choose from a variety of options representing the selection of different action-specific amounts said originator is wanting to introduce in cash in said cash accepting telecommunication device to establish or confirm the call.
